(19) United States
(12) Patent Application Publication
(10) Pub. No.: US 2024/0219640 A1
(43) Pub. Date: Jul. 4, 2024

(54) OPTICAL CIRCUIT, OPTICAL INTEGRATED CIRCUIT, AND METHOD FOR PROVIDING POLARIZATION-INDEPENDENT OUTPUT LIGHT

(71) Applicant: ADVANTEST CORPORATION, Tokyo (JP)

(72) Inventors: Kouichiro UEKUSA, Miyagi (JP); Masahiro ISHIDA, Gunma (JP)

(21) Appl. No.: 18/442,106

(22) Filed: Feb. 15, 2024

Related U.S. Application Data
(63) Continuation of application No. PCT/JP2021/043593, filed on Nov. 29, 2021.

(51) Int. Cl. G02B 6/27; G02B 6/293; G02B 6/35

(52) U.S. Cl. CPC G02B 6/2726; G02B 6/2938; G02B 6/3594

(57) ABSTRACT

An optical circuit includes: a polarization rotation/separation element that spatially separates and outputs a first component which is a component in a first polarization direction, out of input light, and a second component obtained by converting a component in a second polarization direction orthogonal to the first polarization direction, out of the input light, into a component in the first polarization direction; a multiplexer that is disposed on an output side of the polarization rotation/separation element, and multiplexes the first component and the second component; and at least one attenuation element that is disposed on the output side of the polarization rotation/separation element, and attenuates any optical power of one of the first component and the second component, both of the first component and the second component, and multiplexed light multiplexed by the multiplexer.

The contents of the following patent application(s) are incorporated herein by reference:
NO. PCT/JP2021/043593 filed in WO on Nov. 29, 2021

### BACKGROUND

### 1. Technical Field

The present invention relates to an optical circuit, an optical integrated circuit, and a method for providing polarization-independent output light.

### 2. Related Art

Patent Document 1 discloses that: “an input light beam whose plane of polarization is timewisely fluctuated is input to orthogonal polarized wave separating means 12 by variable polarization rotating means 11, and is separated into an S-polarized wave (vertical polarization) and a P-polarized wave (horizontal polarization) . . . two optical paths are multiplexed by multiplexer means 14 . . . polarization rotating means 15 is inserted . . . into . . . the optical paths of the S-polarized wave or the P-polarized wave, so that one plane of polarization (the S-polarized wave) is lined up with the other plane of polarization (the P-polarized wave) and is output as one linearly polarized wave (the P-polarized wave) from the multiplexer means 14 to a polarization-maintaining optical fiber” (paragraph 0008); “as the variable polarization rotating means 11, for example, a Faraday rotator is used . . . as the orthogonal polarized wave separating means 12, for example, a polarization beam splitter or calcite is used” (paragraph 0013); and “as the polarization rotating means 15, for example, a half-wave plate is used” (paragraph 0014).

### PRIOR ART DOCUMENT

### Patent Document

Patent Document 1: Japanese Patent Application Publication No. H09-90299

### BRIEF DESCRIPTION OF THE DRAWINGS

FIG. 1 is a diagram schematically showing an example of an optical integrated circuit 10 including an optical circuit 100 according to a first embodiment.

FIG. 2 is a flowchart showing an example of a method for adjusting an amount of attenuation according to the first embodiment.

FIG. 3 is a flowchart showing an example of a method for providing polarization-independent output light to an optical functional element 50, according to the first embodiment.

FIG. 4 is a diagram schematically showing an example of an optical circuit 101 according to a second embodiment.

FIG. 5 is a diagram schematically showing an example of an optical circuit 200 according to a third embodiment.

FIG. 6 is a flowchart showing an example of a method for adjusting an amount of attenuation according to the third embodiment.

FIG. 7 is a diagram schematically showing an example of an optical circuit 201 according to a fourth embodiment.

FIG. 8 is a diagram schematically showing an example of an optical circuit 300 according to a fifth embodiment.

FIG. 9 is a diagram schematically showing an example of an optical circuit 301 according to a sixth embodiment.

FIG. 10 is a diagram schematically showing an example of an optical circuit 400 according to a seventh embodiment.

FIG. 11 is a flowchart showing an example of a method for providing polarization-independent output light to the optical functional element 50, according to the seventh embodiment.

### DESCRIPTION OF EXEMPLARY EMBODIMENTS

Hereinafter, the present invention will be described through embodiments of the present invention, but the following embodiments do not limit the present invention according to claims. In addition, not all of the combinations of features described in the embodiments are imperative to the solving means of the invention.

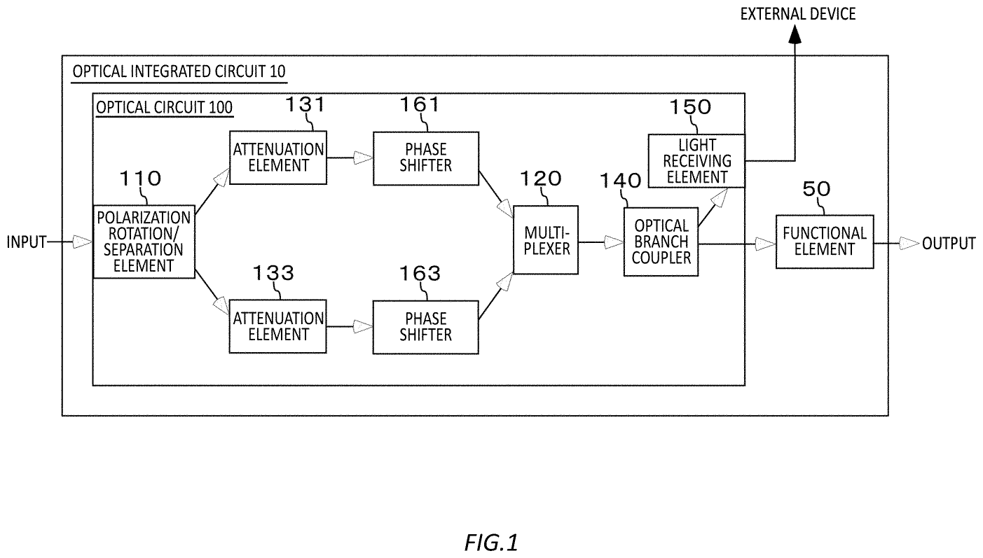

FIG. 1 is a diagram schematically showing an example of an optical integrated circuit 10 including an optical circuit 100 according to a first embodiment. The optical integrated circuit 10 is used, for example, for an optical test as an optical switch of an optical waveguide type, and calibrates input light which is input to the optical integrated circuit 10 and outputs the calibrated input light. The input light is monochromatic and phase-matched coherent light, for example, laser light. The input light may be polarized, or may be in any polarization state. A plane of polarization of the input light may change from moment to moment, or may not change.

In addition, in the present embodiment, an amount of the input light which is input to the optical integrated circuit 10, that is, a magnitude of optical power is known. For example, the magnitude of the optical power is adjusted in advance on an upstream side of the optical integrated circuit 10 such that the optical power of the input light which is input to the optical integrated circuit 10 has a predetermined magnitude. Instead of this, the optical integrated circuit 10 itself may have an adjustment function such that the optical power of the input light which is input to the optical integrated circuit 10 has a predetermined magnitude.

The optical integrated circuit 10 includes an optical functional element 50 and an optical circuit 100. The optical integrated circuit 10 may be an integrated circuit in which the optical functional element 50 and the optical circuit 100 are integrally mounted on the same substrate. The optical functional element 50 may be an optical device of the optical waveguide type, for example, a semiconductor laser, an optical modulator, a photodetector, or the like. The optical functional element 50 has a characteristic that depends on the polarization state of the input light which is input to the optical functional element 50.

The optical circuit 100 is, for example, a circuit of the optical waveguide type in which an optical fiber is used. The optical circuit 100 calibrates the input light which is input to the optical circuit 100 to provide the optical functional element 50 with polarization-independent output light. The optical circuit 100 at least converts the input light into a linearly polarized wave having one polarization direction and outputs the linearly polarized wave.

Specifically, the optical circuit 100 separates the input light into a component in one polarization direction, and a component obtained by converting a component in another polarization direction orthogonal to the one polarization direction, into a component in the one polarization direction; and multiplexes the separated components to output the multiplexed component. It is preferable for the optical circuit 100 to match phases of the two separated components with each other and then multiplex the components.

The optical circuit 100 inputs, to the optical functional element 50, the multiplexed light which is output. The optical circuit 100 attenuates the optical power of the input light which is input to the optical circuit 100, and outputs the multiplexed light. It is preferable for the optical circuit 100 to attenuate the optical power of the input light to the optical power required for the optical functional element 50.

The optical circuit 100 according to the present embodiment includes a polarization rotation/separation element 110, a multiplexer 120, and attenuation elements 131, 133. The polarization rotation/separation element 110 spatially separates and outputs a first component which is a component in a first polarization direction, out of the input light; and a second component obtained by converting a component in a second polarization direction orthogonal to the first polarization direction, out of the input light, into a component in the first polarization direction.

The first component is, for example, a TE-polarized wave (a plane wave in which an electric field is orthogonal to a plane of incidence. An orthogonal polarized wave), and the component in the second polarization direction is, for example, a TM-polarized wave (a plane wave in which a magnetic field is orthogonal to a plane of incidence. A parallel polarized wave), and in this case, the second component obtained by converting the component in the second polarization direction into the component in the first polarization direction is the TE-polarized wave. It should be noted that the first component may be the TM-polarized wave, and the component in the second polarization direction may be the TE-polarized wave.

The polarization rotation/separation element 110 may be, for example, a waveguide that connects an optical circuit A, an optical circuit B, and an optical circuit C, in this order, and the light is input to the optical circuit A and is output from the optical circuit C. In a case where the polarization rotation/separation element 110 has a function of outputting the TE-polarized wave without a conversion, and converting the TM-polarized wave into the TE-polarized wave for outputting, each function of the optical circuit A, the optical circuit B, and the optical circuit C will be described below in detail.

The optical circuit A has a mode conversion function. For a TE-polarized wave input, the optical circuit A outputs a TE fundamental mode as the TE fundamental mode as it is. For a TM-polarized wave input, the optical circuit A converts a TM fundamental mode into a TE primary mode for outputting, by a waveguide structure that destroys symmetry in a vertical direction.

The optical circuit B functions as an asymmetric directional coupler having two waveguides that are adjacent to each other, and the light which is output from the optical circuit A is input to one of the waveguides. For the TE-polarized wave input, the optical circuit B outputs the TE fundamental mode which is input from the optical circuit A, from an output end of the one waveguide, as the TE fundamental mode as it is. For the TM-polarized wave input, the optical circuit B transfers power from the one waveguide described above to the other waveguide and converts, into the TE fundamental mode, the TE primary mode converted from the TM fundamental mode, which is input from the optical circuit A; and outputs the TE fundamental mode obtained by converting from the output end of the other waveguide.

The optical circuit C has two waveguides in which output ends are spatially separated, and the light output from the two output ends of the optical circuit B is input to each of input ends of the two waveguides. For the TE-polarized wave input, the optical circuit C outputs the TE fundamental mode which is input from the optical circuit B to the input end of one waveguide, from the output end of the one waveguide, as the TE fundamental mode as it is. For the TM-polarized wave input, the optical circuit C outputs the TE fundamental mode converted from the TE primary mode, which is input from the optical circuit B to the input end of the other waveguide, from the output end of the other waveguide, as the TE fundamental mode as it is.

The multiplexer 120 is disposed on an output side of the polarization rotation/separation element 110, and multiplexes the first component and the second component that are spatially separated and output by the polarization rotation/separation element 110.

The attenuation elements 131, 133 are disposed on the output side of the polarization rotation/separation element 110. The attenuation elements 131, 133 according to the present embodiment are disposed, between the polarization rotation/separation element 110 and the multiplexer 120, on respective optical paths of the first component and the second component described above that are spatially separated and output by the polarization rotation/separation element 110, on a one to one basis. Specifically, the attenuation element 131 is disposed on the optical path of the TE-polarized wave which is the first component, and the attenuation element 133 is disposed on the optical path of the TE-polarized wave which is the second component converted from the TM-polarized wave that is the component in the second polarization direction.

The attenuation elements 131, 133 may attenuate the optical power of both of the first component and the second component, or only any one of the attenuation elements 131, 133 may attenuate the optical power of the corresponding one of the first component and the second component. When only any one of the attenuation elements 131, 133 attenuates one of the first component and the second component, the other of the attenuation elements 131, 133 may be disposed, or may not be disposed on the optical path of the other of the first component and the second component.

The optical circuit 100 may further include an optical branch coupler 140 and a light receiving element 150. The optical branch coupler 140 according to the present embodiment is disposed on the optical path between both of the multiplexer 120 and the attenuation elements 131, 133, and an output side of the optical circuit 100, and causes a part of the multiplexed light multiplexed by the multiplexer 120 to be branched in a direction different from a path to the output side of the optical circuit 100. The remainder of the multiplexed light multiplexed by the multiplexer 120 travels the path to the output side of the optical circuit 100.

The light receiving element 150 receives the multiplexed light branched by the optical branch coupler 140, out of the multiplexed light multiplexed by the multiplexer 120. The light receiving element 150 according to the present embodiment is provided in the optical circuit 100 together with the optical branch coupler 140, with a purpose to determine in advance amounts of attenuation of the optical power by the attenuation elements 131, 133 such that the optical power of the multiplexed light which is output from the optical circuit 100 has a predetermined magnitude.

Here, in a case where the light receiving element is disposed together with the optical branch coupler on the optical path on an upstream side of at least one of the multiplexer 120 or the attenuation elements 131, 133, there is a possibility that optical insertion loss of the light occurs by the multiplexer 120 or the like that is positioned on a downstream side of the light receiving element or the like, or the waveguide, and in this case, the light receiving element cannot accurately detect the optical power of the output light which is provided to the optical functional element 50. In contrast with this, the light receiving element 150 according to the present embodiment is disposed together with the optical branch coupler 140 on the optical path between both of the multiplexer 120 and attenuation elements 131, 133, and the output side of the optical circuit 100. In this manner, in comparison with the above described case where the light receiving element is disposed on the optical path on the upstream side of at least one of the multiplexer 120 or the attenuation elements 131, 133, the light receiving element 150 can more accurately detect the optical power of the output light which is provided from the optical circuit 100 to the optical functional element 50.

It should be noted that in the present embodiment, the optical branch coupler 140 and the light receiving element 150 may be removed from the optical path of the optical circuit 100 as soon as the amounts of attenuation by the attenuation elements 131, 133 are determined. It should be noted that a signal indicating the magnitude of the optical power detected by the light receiving element 150 may be transmitted to an external device, for example, a personal computer or the like, for the purpose described above. In this case, a user may use the personal computer to determine the amounts of attenuation of the optical power by the attenuation elements 131, 133 such that the optical power of the multiplexed light which is output from the optical circuit 100 has a predetermined magnitude. It should be noted that the optical circuit 100 may include, instead of the light receiving element 150, optical power detection means other than the light receiving element 150.

The optical circuit 100 may further include phase shifters 161,163. The phase shifters 161, 163 match phases of the first component and the second component with each other between the polarization rotation/separation element 110 and the multiplexer 120. The phase shifters 161, 163 may match the phases of the first component and the second component with each other, by delaying the phases of both of the first component and the second component by predetermined amounts.

In addition, any one of the phase shifters 161, 163 may match, by delaying the corresponding one phase of the first component and the second component by a predetermined amount, the phases of the first component and the second component with each other. When only any one of the phase shifters 161, 163 delays the one phase of the first component and the second component, the other of the phase shifters 161, 163 may be disposed, or may not be disposed on the optical path of the other of the first component and the second component. It should be noted that the predetermined amount of the phase delay described above may be determined, for example, in consideration of the characteristic of the polarization rotation/separation element 110.

As an example, the phase shifters 161, 163 may be heaters or the like. Instead of or in addition to the phase shifters 161, 163, the optical circuit 100 may match the phases of the first component and the second component with each other, by adjusting a length of the optical path on which each of the attenuation elements 131, 133 is disposed.

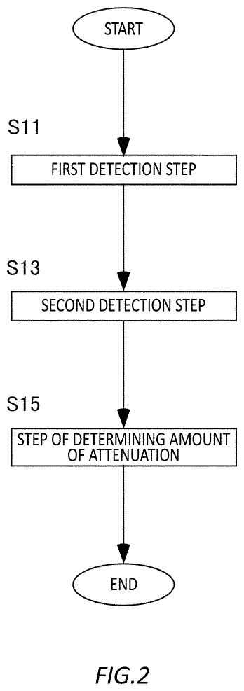

FIG. 2 is a flowchart showing an example of a method for adjusting an amount of attenuation according to the first embodiment. The optical circuit 100 according to the present embodiment executes the method for adjusting an amount of attenuation shown in FIG. 2, as a previous step of executing a method for providing polarization-independent output light to the optical functional element 50.

The optical circuit 100 executes a first detection step (step S11). Specifically, in a state in which the amounts of attenuation of the attenuation elements 131, 133 are set to 0%, only the TE-polarized wave having the known optical power is input to the optical circuit 100, and the optical circuit 100 detects the optical power by the light receiving element 150. The optical circuit 100 transmits, to the external device, a signal indicating the magnitude of the optical power detected by the light receiving element 150. It should be noted that the input light which includes only the TE-polarized wave and does not include the TM-polarized wave is not converted by the polarization rotation/separation element 110, and travels the optical path on which the attenuation element 131 is disposed, and does not travel the optical path on which the attenuation element 133 is disposed.

The optical circuit 100 executes a second detection step (step S13). Specifically, in a state in which the amounts of attenuation of the attenuation elements 131, 133 are set to 0%, only the TM-polarized wave having the same optical power as that in the first detection step is input to the optical circuit 100, and the optical circuit 100 detects the optical power by the light receiving element 150. The optical circuit 100 transmits, to the external device, a signal indicating the magnitude of the optical power detected by the light receiving element 150. It should be noted that the input light which includes only the TM-polarized wave and does not include the TE-polarized wave is converted into the TE-polarized wave by the polarization rotation/separation element 110, and travels the optical path on which the attenuation element 133 is disposed, and does not travel the optical path on which the attenuation element 131 is disposed.

The optical circuit 100 executes a step of adjusting the amount of attenuation based on detection results of the first detection step and the second detection step (step S15). Specifically, the optical circuit 100 determines the amounts of attenuation of the optical power by the attenuation elements 131, 133 such that the optical power of the multiplexed light which is output from the optical circuit 100 has a predetermined magnitude. The predetermined magnitude of the optical power is, for example, the optical power required for the optical functional element 50. This makes it possible for the optical circuit 100 to keep constant the optical power of the multiplexed light which is output from the optical circuit 100, without depending on a ratio of the first component in the first polarization direction and the component in the second polarization direction orthogonal to the first polarization direction, in the input light.

The attenuation elements 131, 133 according to the present embodiment have, as an example, configurations in which the user is able to adjust the amounts of attenuation for attenuating the optical power. As an example, for the amount of attenuation, a ratio of the optical power which is attenuated, to the optical power of the input light, may be expressed as a percentage, and the amount of attenuation may be able to be set in a range of 0 to 100%. Instead of this, the attenuation elements 131, 133 may be selected from a plurality of attenuation elements that are set to the amounts of attenuation different from each other.

The attenuation elements 131, 133 in which the amounts of attenuation are determined as described above, attenuate the optical power of both or one of the first component and the second component, by the amount of attenuation by which the optical power of the multiplexed light that is output from the optical circuit 100 has a predetermined magnitude.

Specifically, the attenuation elements 131, 133 attenuate optical power of at least a component in which a ratio of optical power that is lost by the polarization rotation/separation element 110 is relatively small, between the first component and the second component. The component in which the ratio of the optical power that is lost by the polarization rotation/separation element 110 is relatively small is the second component in which the direction is converted from the second polarization direction to the first polarization direction by the polarization rotation/separation element 110, for example, the TM-polarized wave converted from the TE-polarized wave.

More specifically, the attenuation elements 131, 133 attenuate the optical power of both or one of the first component and the second component, by the amounts of attenuation by which respective ratios of the optical power to be lost in the first component and in the second component, between inputs to the polarization rotation/separation element 110 and inputs to the multiplexer 120, become equal to each other in a predetermined range. In other words, the optical circuit 100 matches the ratios of the insertion losses of the first component and the second component that occur in the optical circuit 100, with each other.

For example, an assumption is that it is found that: as the detection result of the first detection step, the TE-polarized wave having the known optical power loses 10% of the optical power due to passing through the polarization rotation/separation element 110; and as the detection result of the second detection step, the TM-polarized wave having the same optical power loses 20% of the optical power due to being converted into the TE-polarized wave by the polarization rotation/separation element 110. In addition, the optical power required for the optical functional element 50 is set to be 70% of the known optical power. In this case, the optical circuit 100 may determine the amount of attenuation of the attenuation element 131 to be 20%, and may determine the amount of attenuation of the attenuation element 133 to be 10%.

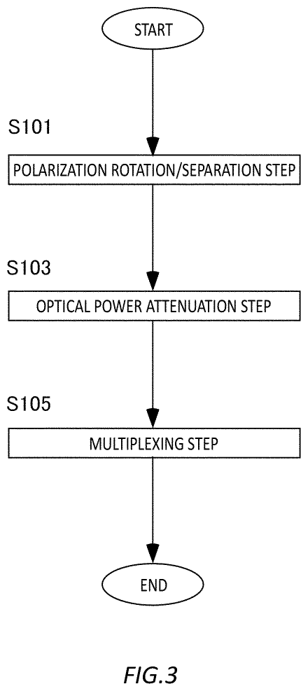

FIG. 3 is a flowchart showing an example of a method for providing polarization-independent output light to an optical functional element 50, according to the first embodiment. By executing the method for adjusting an amount of attenuation shown in the flowchart of FIG. 2, before executing the method shown in the flowchart of FIG. 3, the optical circuit 100 according to the present embodiment adjusts the amounts of attenuation of the optical power by the attenuation elements 131, 133 such that the optical power of the multiplexed light which is output from the optical circuit 100 has a predetermined magnitude.

The optical circuit 100 executes a polarization rotation/separation step (step S101). Specifically, the optical circuit 100 spatially separates and outputs, by the polarization rotation/separation element 110, the first component which is the component in the first polarization direction, out of the input light; and the second component obtained by converting the component in the second polarization direction orthogonal to the first polarization direction, out of the input light, into the component in the first polarization direction.

The optical circuit 100 executes an optical power attenuation step (step S103). Specifically, the optical circuit 100 attenuates the optical power of one or both of the first component and the second component, by the attenuation elements 131, 133 disposed on the output side of the polarization rotation/separation element 110.

The optical circuit 100 executes a multiplexing step (step S105). Specifically, the optical circuit 100 multiplexes the first component and the second component by the multiplexer 120 disposed on the output side of the polarization rotation/separation element 110. In this manner, the optical circuit 100 outputs, for example, the TE-polarized wave as the polarization-independent output light, and inputs the TE-polarized wave to the optical functional element 50.

It should be noted that it is preferable for the optical circuit 100 to match the phases of the first component and the second component with each other by the phase shifters 161, 163 after executing the optical power attenuation step and before executing the multiplexing step.

As described above, the optical circuit 100 according to the present embodiment includes the polarization rotation/separation element 110 that spatially separates and outputs the first component which is the component in the first polarization direction, out of the input light, and the second component obtained by converting the component in the second polarization direction orthogonal to the first polarization direction, out of the input light, into the component in the first polarization direction; and the multiplexer 120 that is disposed on the output side of the polarization rotation/separation element 110 and multiplexes the first component and the second component. The optical circuit 100 further includes at least one of the attenuation elements 131, 133 that are disposed on the output side of the polarization rotation/separation element 110, and attenuate the optical power of one or both of the first component and the second component.

Here, as a comparison example, an optical circuit is assumed to adjust light intensities of a S-polarized wave and a P-polarized wave of the input light by a Faraday rotator, and then separate both polarized waves by a polarizing beam splitter, and then rotate the S-polarized wave by a half-wave plate to set the rotated S-polarized wave to be the P-polarized wave, and multiplexes and outputs the two P-polarized waves. The optical circuit according to the comparison example further has a set of a beam splitter and a photodetector disposed on the optical path of each of the two separated polarized waves, to adjust in real time the light intensities of the S-polarized wave and the P-polarized wave of the input light, and feeds back, to a polarization control circuit, data indicating the light intensity detected by the photodetector.

In contrast with this, with the optical circuit 100 of the present embodiment having the configuration described above, the optical power of one or both of the first component and the second component in the same polarization direction, which are output from the polarization rotation/separation element 110, is attenuated by at least one of the attenuation elements 131, 133 disposed on the output side of the polarization rotation/separation element 110. In comparison with the optical circuit according to the comparison example described above, the optical circuit 100 according to the present embodiment does not need elements such as the Faraday rotator, the polarization beam splitter and the half-wave plate, and the waveguides connecting these elements, and can generate the first component and the second component which have the same polarization direction as each other, and in which the amounts of attenuation are adjusted only by one polarization rotation/separation element 110 and at least one of the attenuation elements 131, 133. This makes it possible for the optical circuit 100 according to the present embodiment to be smaller than the optical circuit according to the comparison example, thereby enabling a contribution to miniaturization of the optical integrated circuit 10 on which the optical circuit 100 is mounted. As a specific example, with the optical circuit 100 according to the present embodiment, the combination of one polarization rotation/separation element 110 and at least one of the attenuation elements 131, 133 can be realized with a size of 100 μm×800 μm or less. In addition, with the optical circuit 100, by adjusting the amounts of attenuation of the optical power by the attenuation elements 131, 133 such that the optical power of the multiplexed light which is output has a predetermined magnitude, it is possible to provide the polarization-independent output light to the optical functional element 50 having a characteristic that depends on the polarization state of the input light.

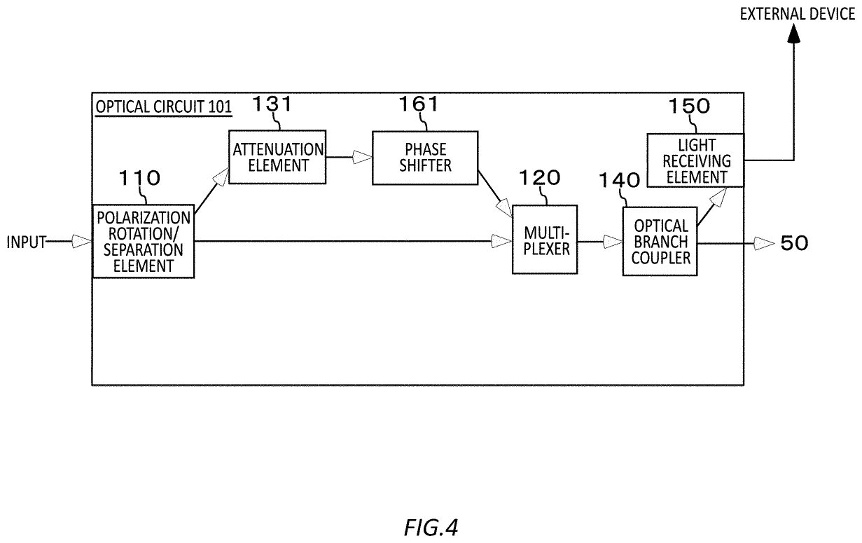

FIG. 4 is a diagram schematically showing an example of an optical circuit 101 according to a second embodiment. The optical circuit 101 according to the present embodiment does not include the set of the attenuation element 133 and the phase shifter 163, and includes only the set of the attenuation element 131 and the phase shifter 161, which is a difference from the optical circuit 100 according to the first embodiment. Other configurations in the optical circuit 101 are the same as the corresponding configurations in the optical circuit 100, and thus the same reference numerals are used to omit redundant descriptions. In addition, for a configuration corresponding to the configuration provided in the optical circuit 100 according to the first embodiment, for example, a configuration having the same function but a different disposal, the same reference numeral as the reference numeral in the optical circuit 100 is used to omit the redundant descriptions. The same applies to a plurality of embodiments described below.

In the optical circuit 101 according to the present embodiment, the attenuation element 131 is disposed between the polarization rotation/separation element 110 and the multiplexer 120, and only on the optical path of the component in which the ratio of the optical power that is lost by the polarization rotation/separation element 110 is relatively small, between the respective optical paths of the first component and the second component. Between the first component and the second component that are separated and output by the polarization rotation/separation element 110, the optical power loss of the second component at a time of being converted from the component in the second polarization direction by the polarization rotation/separation element 110, is relatively great. Therefore, the optical circuit 101 attenuates only the first component by the attenuation element 131, in order to additionally attenuate the optical power of the first component to make the same as the optical power of the second component in which the optical power loss is relatively great. In other words, the attenuation element 131 attenuates the optical power of only the component in which the ratio of the optical power that is lost by the polarization rotation/separation element 110 is relatively small, between the first component and the second component.

In addition, in the optical circuit 101 according to the present embodiment, only the phase shifter 161 is disposed only on the optical path on which the attenuation element 131 is disposed. Instead of this, similar to the configuration of FIG. 1, the phase shifters 161, 163 may be disposed on the respective optical paths, or only the phase shifter 163 may be disposed only on the optical path on which the attenuation element 131 is not disposed.

The optical circuit 101 according to the second embodiment described above also exhibits the same effect as the above described effect of the optical circuit 100 according to the first embodiment.

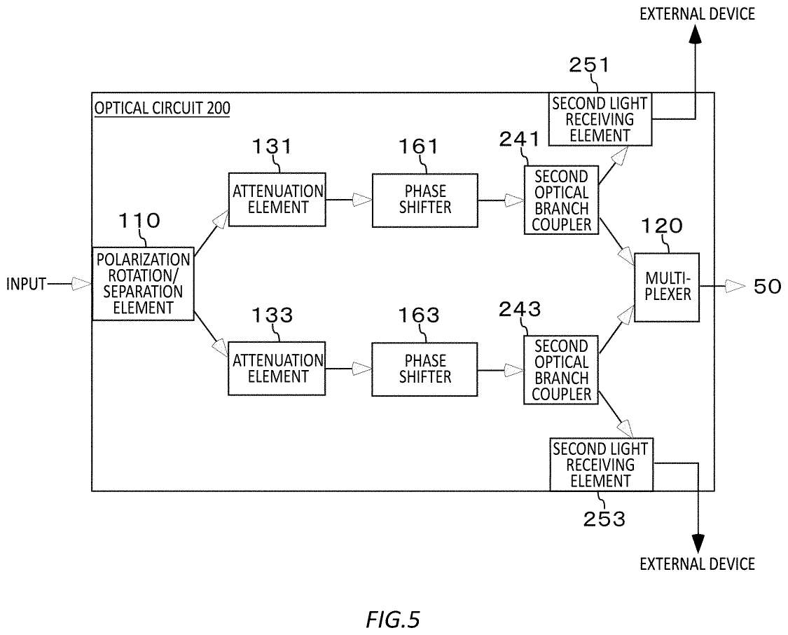

FIG. 5 is a diagram schematically showing an example of an optical circuit 200 according to a third embodiment. The optical circuit 200 according to the present embodiment includes second optical branch couplers 241, 243 and second light receiving elements 251, 253, instead of the optical branch coupler 140 and the light receiving element 150, which is a difference from the optical circuit 100 according to the first embodiment.

The second optical branch couplers 241, 243 are disposed on the respective optical paths of the first component and the second component, between the polarization rotation/separation element 110 and the multiplexer 120, and causes parts of the first component and the second component to be branched in directions different from a path to the multiplexer 120. More specifically, the second optical branch couplers 241, 243 are disposed, between the phase shifters 161, 163 and the multiplexer 120, on the respective optical paths of the first component and the second component. The second light receiving elements 251, 253 receive parts of the first component and the second component which are branched by the second optical branch couplers 241, 243.

Similar to the light receiving element 150 according to the first embodiment, the second light receiving elements 251, 253 are provided in the optical circuit 200 together with the second optical branch couplers 241, 243 with a purpose to determine in advance the amounts of attenuation of the optical power by the attenuation elements 131, 133 such that the optical power of the multiplexed light which is output from the optical circuit 200 has a predetermined magnitude.

Here, in a case where the light receiving element is disposed together with the optical branch coupler only on the optical path of any one of the first component and the second component, it is not possible to detect the optical power of the other of the first component and the second component, whereby it is not possible to achieve the purpose described above. In addition, in a case where the light receiving elements are disposed together with the optical branch couplers on the optical paths of the first component and the second component on an upstream side of the phase shifters 163, 161, there is a possibility that optical insertion loss occurs by the phase shifters 161, 163 that are positioned on the downstream side of the light receiving element or the like, or the waveguide, and in this case, the light receiving element cannot accurately detect the optical power of the output light which is provided to the optical functional element 50. In contrast with this, the second light receiving elements 251, 253 according to the present embodiment are disposed together with the second optical branch couplers 241, 243, between the phase shifters 161, 163 and the multiplexer 120, on the respective optical paths of the first component and the second component. This makes it possible for the second light receiving elements 251, 253 to avoid any problem described above.

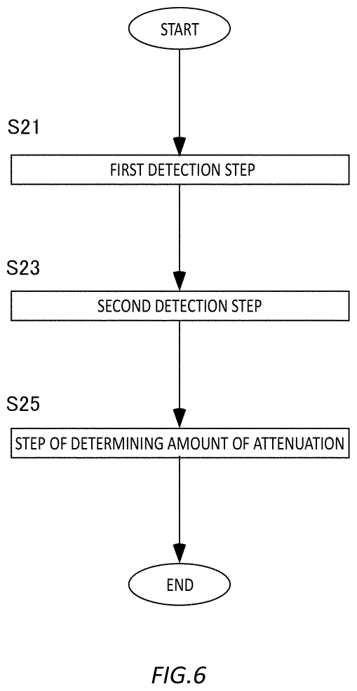

FIG. 6 is a flowchart showing an example of a method for adjusting an amount of attenuation according to the third embodiment. The optical circuit 200 according to the present embodiment executes the method for adjusting an amount of attenuation shown in FIG. 6, as a previous step of executing the method for providing polarization-independent output light to the optical functional element 50 shown in the flowchart of FIG. 3.

The optical circuit 200 executes a first detection step (step S21). Specifically, in a state in which the amounts of attenuation of the attenuation elements 131, 133 are set to 0%, only the TE-polarized wave having the known optical power is input to the optical circuit 200, and the optical circuit 200 detects the optical power by the second light receiving element 251. The optical circuit 200 transmits, to the external device, a signal indicating the magnitude of the optical power detected by the second light receiving element 251. It should be noted that the input light which includes only the TE-polarized wave and does not include the TM-polarized wave is not converted by the polarization rotation/separation element 110, and travels the optical path on which the attenuation element 131 is disposed, and does not travel the optical path on which the attenuation element 133 is disposed.

The optical circuit 200 executes a second detection step (step S23). Specifically, in a state in which the amounts of attenuation of the attenuation elements 131, 133 are set to 0%, only the TM-polarized wave having the same optical power as that in the first detection step is input to the optical circuit 200, and the optical circuit 200 detects the optical power by the second light receiving element 253. The optical circuit 200 transmits, to the external device, a signal indicating the magnitude of the optical power detected by the second light receiving element 253. It should be noted that the input light which includes only the TM-polarized wave and does not include the TE-polarized wave is converted into the TE-polarized wave by the polarization rotation/separation element 110, and travels the optical path on which the attenuation element 133 is disposed, and does not travel the optical path on which the attenuation element 131 is disposed.

The optical circuit 200 executes a step of adjusting the amount of attenuation based on the detection results of the first detection step and the second detection step (step S25). Step S25 is similar to step S15 shown in the flowchart of FIG. 2, and thus the redundant descriptions will be omitted.

The optical circuit 200 according to the third embodiment described above also exhibits the same effect as the above described effect of the optical circuit 100 according to the first embodiment.

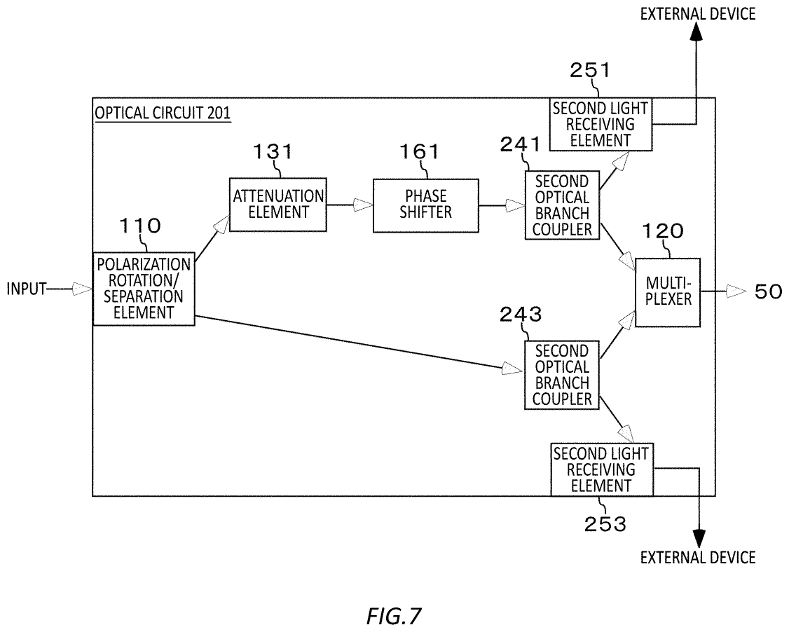

FIG. 7 is a diagram schematically showing an example of an optical circuit 201 according to a fourth embodiment. The optical circuit 201 according to the present embodiment does not include the set of the attenuation element 133 and the phase shifter 163, and includes only the set of the attenuation element 131 and the phase shifter 161, which is a difference from the optical circuit 200 according to the third embodiment.

In the optical circuit 201 according to the present embodiment, similar to the optical circuit 101 according to the second embodiment, the attenuation element 131 is disposed between the polarization rotation/separation element 110 and the multiplexer 120, and only on the optical path of the component in which the ratio of the optical power that is lost by the polarization rotation/separation element 110 is relatively small, between the respective optical paths of the first component and the second component. That is, the optical circuit 201 attenuates only the first component by the attenuation element 131, in order to additionally attenuate the optical power of the first component to make the same as the optical power of the second component in which the optical power loss is relatively great. In other words, the attenuation element 131 attenuates the optical power of only the component in which the ratio of the optical power that is lost by the polarization rotation/separation element 110 is relatively small, between the first component and the second component.

In addition, in the optical circuit 201 according to the present embodiment, similar to the optical circuit 101 according to the second embodiment, only the phase shifter 161 is disposed only on the optical path on which the attenuation element 131 is disposed. Instead of this, similar to the configuration of FIG. 5, the phase shifters 161, 163 may be disposed on the respective optical paths, or only the phase shifter 163 may be disposed only on the optical path on which the attenuation element 131 is not disposed.

The optical circuit 201 according to the fourth embodiment described above also exhibits the same effect as the above described effect of the optical circuit 100 according to the first embodiment.

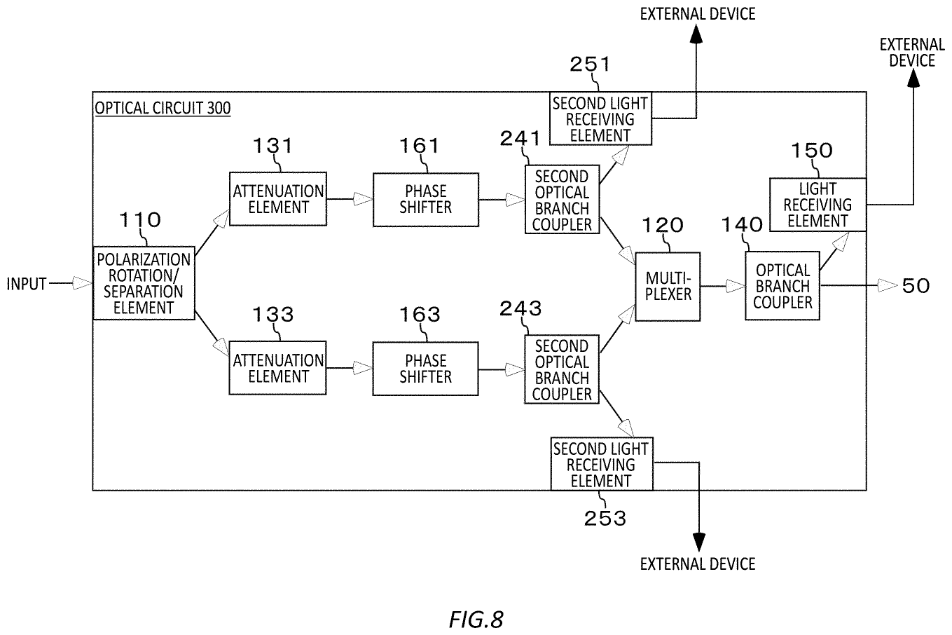

FIG. 8 is a diagram schematically showing an example of an optical circuit 300 according to a fifth embodiment. The optical circuit 300 according to the present embodiment includes the second optical branch couplers 241, 243 and the second light receiving elements 251, 253, in addition to the configuration of the optical circuit 100, which is a difference from the optical circuit 100 according to the first embodiment. In other words, the optical circuit 300 according to the present embodiment has a configuration in which the configuration that the optical circuit 100 according to the first embodiment has and the configuration that the optical circuit 200 according to the third embodiment has, are combined.

As a previous step of executing the method for providing polarization-independent output light to the optical functional element 50 shown in the flowchart of FIG. 3, the optical circuit 300 according to the present embodiment may execute the method for adjusting an amount of attenuation shown in the flowchart of FIG. 2, may execute the method for adjusting an amount of attenuation shown in the flowchart of FIG. 6, or may simultaneously or sequentially execute these two methods for adjusting the amounts of attenuation.

The optical circuit 300 according to the fifth embodiment described above also exhibits the same effect as the above described effect of the optical circuit 100 according to the first embodiment.

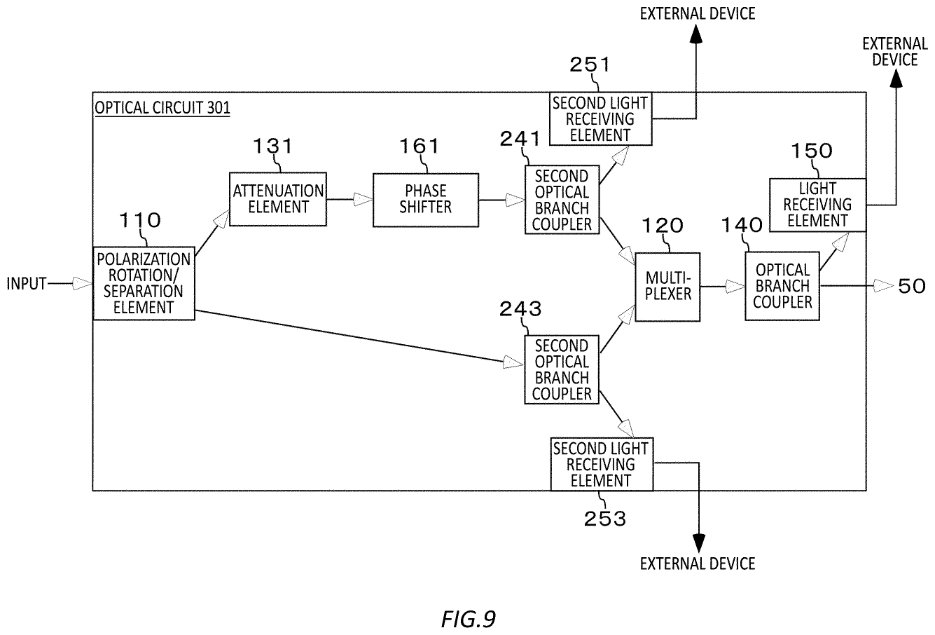

FIG. 9 is a diagram schematically showing an example of an optical circuit 301 according to a sixth embodiment. The optical circuit 301 according to the present embodiment does not include the set of the attenuation element 133 and the phase shifter 163, and includes only the set of the attenuation element 131 and the phase shifter 161, which is a difference from the optical circuit 300 according to the fifth embodiment.

In the optical circuit 301 according to the present embodiment, similar to the optical circuit 101 according to the second embodiment, the attenuation element 131 is disposed between the polarization rotation/separation element 110 and the multiplexer 120, and only on the optical path of the component in which the ratio of the optical power that is lost by the polarization rotation/separation element 110 is relatively small, between the respective optical paths of the first component and the second component. That is, the optical circuit 301 attenuates only the first component by the attenuation element 131, in order to additionally attenuate the optical power of the first component to make the same as the optical power of the second component in which the optical power loss is relatively great. In other words, the attenuation element 131 attenuates the optical power of only the component in which the ratio of the optical power that is lost by the polarization rotation/separation element 110 is relatively small, between the first component and the second component.

In addition, in the optical circuit 301 according to the present embodiment, similar to the optical circuit 101 according to the second embodiment, only the phase shifter 161 is disposed only on the optical path on which the attenuation element 131 is disposed. Instead of this, similar to the configuration of FIG. 8, the phase shifters 161, 163 may be disposed on the respective optical paths, or only the phase shifter 163 may be disposed only on the optical path on which the attenuation element 131 is not disposed.

It should be noted that the optical circuit 301 may not include the second optical branch coupler 243 and the second light receiving element 253 in the configuration shown in FIG. 9. In this case, as a previous step of executing the method for providing polarization-independent output light to the optical functional element 50 shown in the flowchart of FIG. 3, the optical circuit 301 that does not include the second optical branch coupler 243 and the second light receiving element 253 may execute the method for adjusting an amount of attenuation shown in the flowchart in FIG. 2, or may execute the method for adjusting an amount of attenuation which includes a combination of step S21 and step S25 shown in the flowchart of FIG. 6, and step S13 shown in the flowchart of FIG. 2.

Specifically for the latter, in a state in which the amounts of attenuation of the attenuation elements 131, 133 are set to 0%, only the TE-polarized wave having the known optical power is input to the optical circuit 301, and the optical circuit 301 detects the optical power by the second light receiving element 251. Only the TM-polarized wave having the same optical power as this is input to the optical circuit 301, and the optical circuit 301 detects the optical power by the light receiving element 150. The optical circuit 301 executes step S25 described above based on these detection results.

It should be noted that the optical circuit 301 may include the second optical branch coupler 243 and the second light receiving element 253, while not including the second optical branch coupler 241 and the second light receiving element 251. As an example of the method for adjusting an amount of attenuation in this case, in a state in which the amounts of attenuation of the attenuation elements 131, 133 are set to 0%, only the TE-polarized wave having the known optical power is input to the optical circuit 301, and the optical circuit 301 detects the optical power by the light receiving element 150. Only the TM-polarized wave having the same optical power as this is input to the optical circuit 301, and the optical circuit 301 detects the optical power by the second light receiving element 253. The optical circuit 301 executes step S25 described above based on these detection results.

The optical circuit 301 according to the sixth embodiment described above also exhibits the same effect as the above described effect of the optical circuit 100 according to the first embodiment.

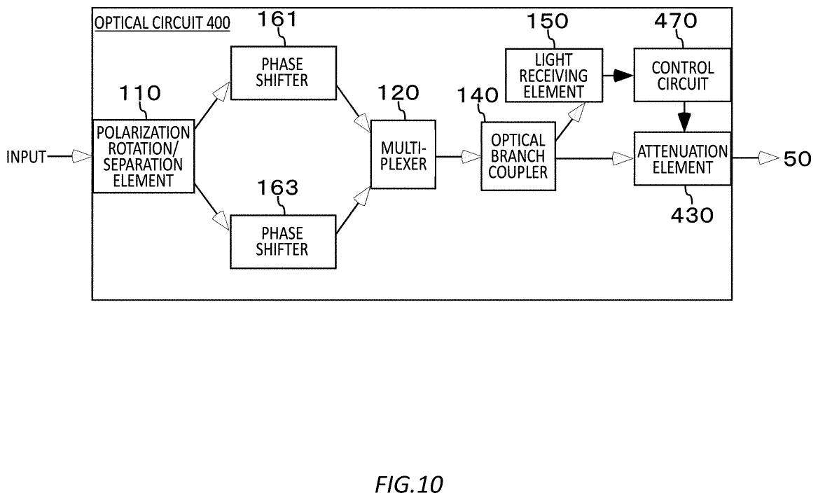

FIG. 10 is a diagram schematically showing an example of an optical circuit 400 according to a seventh embodiment. The optical circuit 400 according to the present embodiment does not include the set of the attenuation elements 131, 133, and includes an attenuation element 430 and a control circuit 470, which is a difference from the optical circuit 100 according to the first embodiment.

With the optical circuit 400 according to the present embodiment, the attenuation element 430 attenuates the optical power of the multiplexed light multiplexed by the multiplexer 120. More specifically, the attenuation element 430 is disposed between the multiplexer 120 and the output side of the optical circuit 400, and attenuates the optical power of the multiplexed light by the amount of attenuation by which the optical power of the multiplexed light that is output from the optical circuit 400 has a predetermined magnitude.

The control circuit 470 controls in real time the amount of attenuation by the attenuation element 430, based on the magnitude of the optical power detected by the light receiving element 150 via the optical branch coupler 140. In the optical circuit 400 according to the present embodiment, the optical branch coupler 140 is disposed on the optical path between the multiplexer 120 and the attenuation element 430, and causes a part of the multiplexed light to be branched in a direction different from a path to the attenuation element 430. The light receiving element 150 receives the multiplexed light branched by the optical branch coupler 140, out of the multiplexed light multiplexed by the multiplexer 120. The light receiving element 150 according to the present embodiment is provided in the optical circuit 400 together with the optical branch coupler 140, with a purpose to adjust in real time the amount of attenuation of the optical power by the attenuation element 430 such that the optical power of the multiplexed light which is output from the optical circuit 100 has a predetermined magnitude. Thereby, in the present embodiment, the optical branch coupler 140 and the light receiving element 150 are necessary for executing the method for the optical circuit 400 to provide the polarization-independent output light to the optical functional element 50.

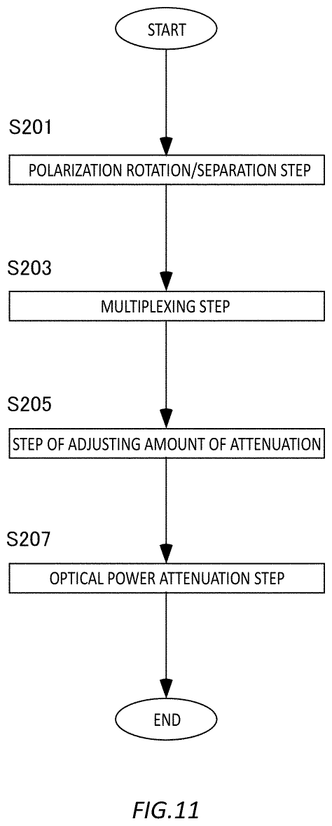

FIG. 11 is a flowchart showing an example of a method for providing polarization-independent output light to the optical functional element 50, according to the seventh embodiment.

The optical circuit 400 according to the present embodiment executes a polarization rotation/separation step (step S201). Specifically, the optical circuit 400 spatially separates and outputs, by the polarization rotation/separation element 110, the first component which is the component in the first polarization direction, out of input light; and the second component obtained by converting the component in the second polarization direction orthogonal to the first polarization direction, out of the input light, into the component in the first polarization direction.

The optical circuit 400 executes a multiplexing step (step S203). Specifically, the optical circuit 400 multiplexes the first component and the second component by the multiplexer 120 disposed on the output side of the polarization rotation/separation element 110. It should be noted that it is preferable for the optical circuit 400 to match the phases of the first component and the second component with each other by the phase shifters 161, 163 after executing the polarization rotation/separation step and before executing the multiplexing step.

The optical circuit 400 executes a step of adjusting the amount of attenuation (step S205). Specifically, the optical circuit 400 adjusts the amount of attenuation of the optical power by the attenuation element 430 such that the optical power of the multiplexed light which is output has a predetermined magnitude. More specifically, the control circuit 470 of the optical circuit 400 adjusts in real time the amount of attenuation of the optical power by the attenuation element 430 such that the optical power of the multiplexed light which is output from the optical circuit 100 has a predetermined magnitude, based on the magnitude of the optical power detected by the light receiving element 150 via the optical branch coupler 140.

The optical circuit 400 executes an optical power attenuation step (step S207). Specifically, the optical circuit 400 attenuates the optical power of the multiplexed light multiplexed by the multiplexer 120, by the attenuation element 430 disposed on the output side of the polarization rotation/separation element 110. In this manner, the optical circuit 400 outputs, for example, the TE-polarized wave as the polarization-independent output light, and inputs the TE-polarized wave to the optical functional element 50.

The optical circuit 400 according to the seventh embodiment described above also exhibits the same effect as the above described effect of the optical circuit 100 according to the first embodiment.

While the present invention has been described by way of the embodiments, the technical scope of the present invention is not limited to the above described embodiments. It is apparent to persons skilled in the art that various alterations or improvements can be made to the above described embodiments. It is also apparent from the scope of the claims that the embodiments added with such alterations or improvements can be included in the technical scope of the present invention.

Note that the operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 optical integrated circuit
50 optical functional element
100, 101, 200, 201, 300, 301, 400 optical circuit
110 polarization rotation/separation element
120 multiplexer
131, 133, 430 attenuation element
140 optical branch coupler
150 light receiving element
161, 163 phase shifter
241, 243 second optical branch coupler
251, 253 second light receiving element
470 control circuit.

What is claimed is:

1. An optical circuit comprising:
a polarization rotation/separation element that spatially separates and outputs
a first component which is a component in a first polarization direction, out of input light, and
a second component obtained by converting a component in a second polarization direction orthogonal to the first polarization direction, out of the input light, into a component in the first polarization direction;
a multiplexer that is disposed on an output side of the polarization rotation/separation element, and multiplexes the first component and the second component; and
at least one attenuation element that is disposed on the output side of the polarization rotation/separation element, and attenuates any optical power of one of the first component and the second component, both of the first component and the second component, and multiplexed light multiplexed by the multiplexer.

2. The optical circuit according to claim 1, wherein
the at least one attenuation element attenuates any of the optical power, by an amount of attenuation by which the optical power of the multiplexed light that is output from the optical circuit has a predetermined magnitude.

3. The optical circuit according to claim 1, wherein
the at least one attenuation element is disposed between the polarization rotation/separation element and the multiplexer, and attenuates optical power of at least a component in which a ratio of optical power that is lost by the polarization rotation/separation element is relatively small, between the first component and the second component.

4. The optical circuit according to claim 2, wherein
the at least one attenuation element is disposed between the polarization rotation/separation element and the multiplexer, and attenuates optical power of at least a component in which a ratio of optical power that is lost by the polarization rotation/separation element is relatively small, between the first component and the second component.

5. The optical circuit according to claim 3, wherein
the at least one attenuation element attenuates any of the optical power, by an amount of attenuation by which respective ratios of the optical power to be lost in the first component and in the second component, between inputs to the polarization rotation/separation element and inputs to the multiplexer, become equal to each other in a predetermined range.

6. The optical circuit according to claim 4, wherein
the at least one attenuation element attenuates any of the optical power, by an amount of attenuation by which respective ratios of the optical power to be lost in the first component and in the second component, between inputs to the polarization rotation/separation element and inputs to the multiplexer, become equal to each other in a predetermined range.

7. The optical circuit according to claim 3, wherein
the at least one attenuation element is disposed, between the polarization rotation/separation element and the multiplexer, on respective optical paths of the first component and the second component on a one to one basis.

8. The optical circuit according to claim 4, wherein
the at least one attenuation element is disposed, between the polarization rotation/separation element and the multiplexer, on respective optical paths of the first component and the second component on a one to one basis.

9. The optical circuit according to claim 5, wherein
the at least one attenuation element is disposed, between the polarization rotation/separation element and the multiplexer, on respective optical paths of the first component and the second component on a one to one basis.

10. The optical circuit according to claim 6, wherein
the at least one attenuation element is disposed, between the polarization rotation/separation element and the multiplexer, on respective optical paths of the first component and the second component on a one to one basis.

11. The optical circuit according to claim 3, wherein
the at least one attenuation element is disposed between the polarization rotation/separation element and the multiplexer, and only on an optical path of the component in which the ratio of the optical power that is lost by the polarization rotation/separation element is relatively small, between respective optical paths of the first component and the second component.

12. The optical circuit according to claim 4, wherein
the at least one attenuation element is disposed between the polarization rotation/separation element and the multiplexer, and only on an optical path of the component in which the ratio of the optical power that is lost by the polarization rotation/separation element is relatively small, between respective optical paths of the first component and the second component.

13. The optical circuit according to claim 5, wherein
the at least one attenuation element is disposed between the polarization rotation/separation element and the multiplexer, and only on an optical path of the component in which the ratio of the optical power that is lost by the polarization rotation/separation element is relatively small, between respective optical paths of the first component and the second component.

14. The optical circuit according to claim 1, further comprising:
an optical branch coupler that is disposed on an optical path between both of the multiplexer and the at least one attenuation element, and an output side of the optical circuit, and causes a part of the multiplexed light to be branched in a direction different from a path to the output side of the optical circuit; and
a light receiving element that receives a part of the multiplexed light branched by the optical branch coupler, to determine in advance an amount of attenuation of the optical power by the at least one attenuation element such that the optical power of the multiplexed light which is output from the optical circuit has a predetermined magnitude.

15. The optical circuit according to claim 1, further comprising:
a second optical branch coupler that is disposed on an optical path of each of the first component and the second component, between the polarization rotation/separation element and the multiplexer, and causes a part of each of the first component and the second component to be branched in a direction different from a path to the multiplexer; and
a second light receiving element that receives a part of each of the first component and the second component branched by the second optical branch coupler, to determine in advance an amount of attenuation of the optical power by the at least one attenuation element such that the optical power of the multiplexed light which is output from the optical circuit has a predetermined magnitude.

16. The optical circuit according to claim 1, wherein
the at least one attenuation element is disposed between the multiplexer and an output side of the optical circuit, and attenuates the optical power of the multiplexed light by an amount of attenuation by which the optical power of the multiplexed light that is output from the optical circuit has a predetermined magnitude.

17. The optical circuit according to claim 16, further comprising:
an optical branch coupler that is disposed on an optical path between the multiplexer and the at least one attenuation element, and causes a part of the multiplexed light to be branched in a direction different from a path to the at least one attenuation element; and
a light receiving element that receives a part of the multiplexed light branched by the optical branch coupler, to adjust in real time an amount of attenuation of the optical power by the at least one attenuation element such that the optical power of the multiplexed light which is output from the optical circuit has a predetermined magnitude.

18. The optical circuit according to claim 1, further comprising:
at least one phase shifter that matches phases of the first component and the second component with each other between the polarization rotation/separation element and the multiplexer.

19. An optical integrated circuit comprising:
an optical functional element; and
the optical circuit according to claim 1, wherein
the optical circuit inputs, to the optical functional element, the multiplexed light which is output.

20. A method comprising:
spatially separating and outputting, by a polarization rotation/separation element,
a first component which is a component in a first polarization direction, out of input light, and
a second component obtained by converting a component in a second polarization direction orthogonal to the first polarization direction, out of the input light, into a component in the first polarization direction;
multiplexing the first component and the second component, by a multiplexer that is disposed on an output side of the polarization rotation/separation element;
attenuating any optical power of one of the first component and the second component, both of the first component and the second component, and multiplexed light multiplexed by the multiplexer, by at least one attenuation element that is disposed on the output side of the polarization rotation/separation element; and
adjusting an amount of attenuation of the optical power by the at least one attenuation element such that the optical power of the multiplexed light which is output has a predetermined magnitude.
